(19) United States
(12) Patent Application Publication
(10) Pub. No.: US 2024/0378622 A1
(43) Pub. Date: Nov. 14, 2024

(54) SYSTEMS AND METHODS FOR AUTOMATED SILENT INFERENCE OF CLIENT INTERACTION

(71) Applicant: JPMORGAN CHASE BANK, N.A., New York, NY (US)

(72) Inventors: Joel POTTS, London (GB); Daniel J ZINKIN, London (GB)

(21) Appl. No.: 18/660,934

(22) Filed: May 10, 2024

Related U.S. Application Data
(60) Provisional application No. 63/501,876, filed on May 12, 2023.

(51) Int. Cl. G06Q 30/01; G06Q 10/0639

(52) U.S. Cl. CPC G06Q 30/01; G06Q 10/06395

(57) ABSTRACT

Systems and methods for automated silent inference of client interaction are disclosed. According to an embodiment, a method may include: (1) receiving, by a computer program executed by a backend electronic device, client or customer interaction data for a plurality of client or customer interactions from a plurality of sources; (2) generating, by the computer program, an interaction value score each of the customer or client interactions using a trained machine learning algorithm; and (3) providing, by the computer program, the client or customer interactions and the interaction value score for each of the client or customer interactions to a customer relationship management computer program.

### RELATED APPLICATIONS

This application claims priority to, and the benefit of, U.S. Provisional Patent Application Ser. No. 63/501,876, filed May 12, 2023, the disclosure of which is hereby incorporated, by reference, in its entirety.

### BACKGROUND OF THE INVENTION

### 1. Field of the Invention

Embodiments relate to systems and methods for automated silent inference of client interaction.

### 2. Description of the Related Art

Historically, data regarding an interaction between a company and one of its customers or clients is manually input into a system. For example, a user, such as a company employee, may enter data for the interaction into a customer relationship management (CRM) program, into a diary that may be synchronized with the CRM program, may enter data into a calendaring program that may be synchronized with the CRM program, etc. The user may enter details, such as the name of the client, the topics of discussion, etc.

### SUMMARY OF THE INVENTION

Systems and methods for automated silent inference of client interaction are disclosed. According to an embodiment, a method may include: (1) receiving, by a computer program executed by a backend electronic device, client or customer interaction data for a plurality of client or customer interactions from a plurality of sources; (2) generating, by the computer program, an interaction value score each of the customer or client interactions using a trained machine learning algorithm; and (3) providing, by the computer program, the client or customer interactions and the interaction value score for each of the client or customer interactions to a customer relationship management computer program.

In one embodiment, the plurality of sources comprise calendaring programs, email programs, video conferencing programs, telephone logs, and/or chat and messaging data.

In one embodiment, the client or customer interaction data may include meeting information. The meeting information may include meeting dates, meeting participants, meeting subjects, meeting locations, a number of communications, a number of participants, and/or a sentiment.

In one embodiment, the method may also include: generating, by the computer program and using the customer interaction data, a profile for each client or customer; wherein the profile for each client or customer may include a plurality of email addresses, a plurality of phone numbers, a video conference address, and/or a chat and messaging handle.

In one embodiment, the method may also include: identifying, by the computer program, the client or customer in the client or customer interaction data using common names, subjects, dates, electronic device data, IP addresses, and/or locations in the client or customer interaction data.

In one embodiment, the method may also include: identifying, by the computer program, false positive client or customer interactions; and excluding or discounting, by the computer program, the client or customer interaction data associated with the identified false positive client or customer interactions. The false positive client or customer interactions comprise client or customer interaction data including an out-of-office reply and/or an interaction with an assistant.

In one embodiment, in-person client or customer interactions and/or direct client or customer interactions score as high value interactions, and virtual group client or customer interactions score may be scored as lower value interactions.

According to another embodiment, a system may include: a plurality of sources of client or customer interaction data; a customer relationship manager computer system; and a backend electronic device that may be configured to receive, from the plurality of sources of client or customer interaction data, the client or customer interaction data for a plurality of client or customer interactions; to generate an interaction value score each of the customer or client interactions using a trained machine learning algorithm; and to provide the client or customer interactions and the interaction value score for each of the client or customer interactions to a customer resource management system.

In one embodiment, the plurality of sources of client or customer interaction data comprise calendaring programs, email programs, video conferencing programs, telephone logs, and/or chat and messaging data.

In one embodiment, the client or customer interaction data may include meeting information. The meeting information may include meeting dates, meeting participants, meeting subjects, meeting locations, a number of communications, a number of participants, and/or a sentiment.

In one embodiment, the backend electronic device may be further configured to generate, using the customer interaction data, a profile for each client or customer, wherein the profile for each client or customer may include a plurality of email addresses, a plurality of phone numbers, a video conference address, and/or a chat and messaging handle.

In one embodiment, the backend electronic device may be further configured to identify the client or customer in the client or customer interaction data using common names, subjects, dates, electronic device data, IP addresses, and/or locations in the client or customer interaction data.

In one embodiment, the backend electronic device may be further configured to identify false positive client or customer interactions; and to exclude or discount the client or customer interaction data associated with the identified false positive client or customer interactions. The false positive client or customer interactions comprise client or customer interaction data including an out-of-office reply and/or an interaction with an assistant.

In one embodiment, in-person client or customer interactions and/or direct client or customer interactions score as high value interactions, and virtual group client or customer interactions score may be scored as lower value interactions.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for automated silent inference of client interaction according to an embodiment;

FIG. 2 depicts a method for automated silent inference of client interaction according to an embodiment; and

FIG. 3 depicts an exemplary computing system for implementing aspects of the present disclosure.

### DETAILED DESCRIPTION OF PREFERRED EMBODIMENTS

Embodiments relate to systems and methods for automated silent inference of client interaction. For example, embodiments may infer user interactions with customers or clients without requiring manual entry of interaction data.

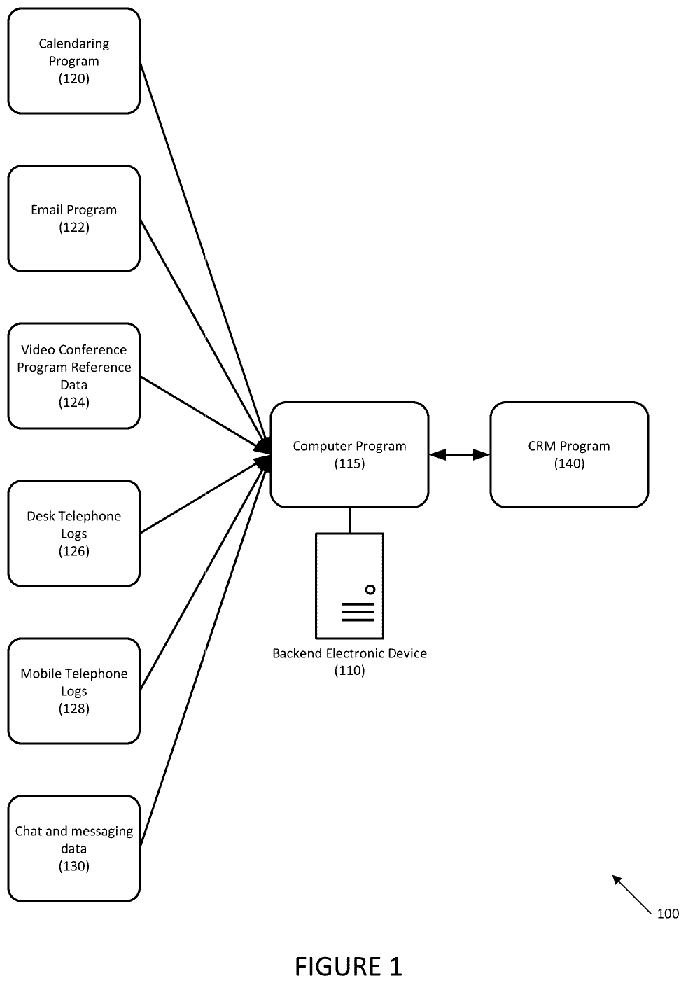

Referring to FIG. 1, a system for automated silent inference of client interaction is disclosed according to an embodiment. System 100 may include electronic device 110, which may be a server (e.g., physical and/or cloud based), a computer (e.g., workstation, desktop, laptop, notebook, tablet, etc.), etc. Electronic device 110 may execute one or more computer programs or applications 115.

Computer program 115 may receive data from a plurality of data sources, such as calendaring program 120, email program 122, video conferencing program 124, desk telephone logs 126, mobile telephone logs 128, chat and messaging data 130, etc. For example, computer program 115 may receive meeting information (e.g., dates, participants, subjects, locations) from calendaring program 120, emails (participants, dates and times, subjects, etc.) from email program 122, reference data for video calls (e.g., participants, date and time, etc.) from video conferencing program 124, desk telephone call data (e.g., caller, date and time of call, call duration, etc.) from desk telephone logs 126, mobile telephone call data (e.g., caller, date and time of call, call duration, location, etc.) from mobile telephone logs 128, and chat and messaging data (e.g., participants, time and date, topics, etc.) from chat and messaging data 130.

Computer program 115 may use the data from these data sources and may create a profile for each customer or client. For example, each client or customer may have a plurality of email addresses (e.g., work, personal, etc.), phone numbers (e.g., desk phone, corporate mobile phone, personal mobile phone, etc.), video conference addresses, chat and messaging handles, etc. For example, using metadata associated with each bit of data, computer program may identify contact information that is likely to be associated with a single client. Computer program 115 may use common names, subjects, dates, electronic device data (e.g., device fingerprints), IP addresses, locations, etc. to identify common contact information for a client.

In one embodiment, signature scraping of emails or other messages may be used to identify the client.

In one embodiment, the user profile may also identify the manner in which the client or customer has accessed organizational content, such as by application or browser, from a certain type of computer (e.g., PC, Mac, mobile device), how the user navigated to the content (e.g., from a social network, from an application, via a link in an email, from a search result, etc.), etc.

Computer program 115 may also assess a value of an interaction. For example, an in-person meeting between a user and a client may be scored as a high value interaction. A virtual one-one-one meeting between the user and the client may be scored as a high value interaction. A direct user to client telephone call may be scored as a high value interaction. Group meetings, such as virtual group meetings, video or conference calls, etc. may have lower scores. In one embodiment, machine learning may be used to determine the score for each interaction.

In one embodiment, additional metadata, such as whether cameras were turned on during a virtual meeting, the length of the meeting, the number of emails in a chain, the number of email participants, the client's speed of response to an email or message, a sentiment in the response, etc. may also be used to determine the score.

In one embodiment, interactions may be grouped to assess a value for the interaction. For example, a long email interaction with a positive sentiment may have a value that may be similar to a one-on-one in-person meeting. This may also lead to discounting email that may include out of office replies, spam, etc.

Embodiments may discount false-positive interactions, such as out-of-office replies, conversations with assistants, etc.

In one embodiment, the cadence of the emails in an email string may be used to determine a number of interactions.

In one embodiment, an interaction may be scored highly if it leads to a follow-up interaction. For example, a single email or message may be given a high value score if it leads to setting up or suggesting a follow-up meeting, such as an in-person meeting.

In one embodiment, artificial intelligence may be used to identify the context of the interactions.

Computer program 115 may provide the client interactions, including a user identifier (e.g., employee name), client/customer information, date and time, location, type of interaction, and a value score for the interactions to CRM program 140. CRM program 140 may ingest the interactions and further process the interactions as is necessary and/or desired.

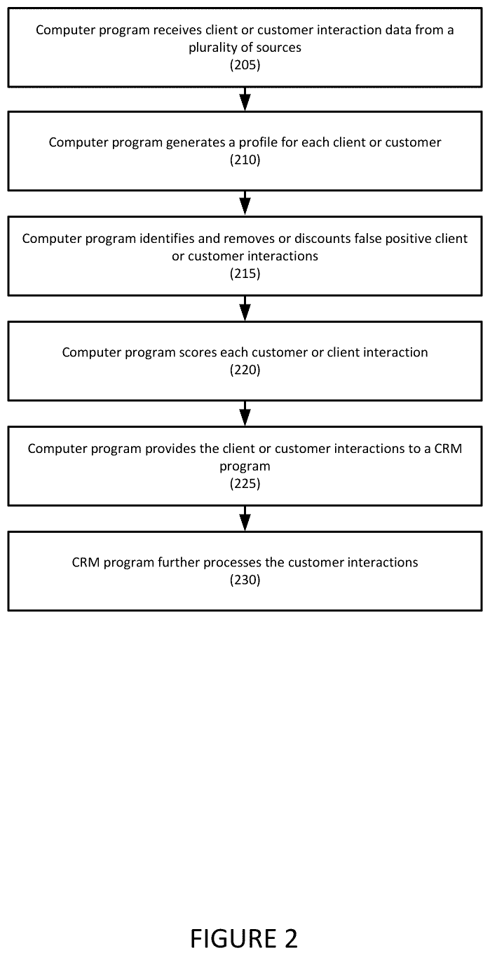

Referring to FIG. 2, a method for automated silent inference of client interaction is provided according to an embodiment.

In step 205, a computer program executed by a backend electronic device may receive client or customer interaction data from a plurality of sources. Examples of sources may include calendaring programs, email programs, video conferencing programs, desk telephone logs, mobile telephone logs, chat and messaging data, etc. For example, the computer program may receive meeting information (e.g., dates, participants, subjects, locations) from calendaring programs, emails (participants, dates and times, subjects, etc.) from email programs, reference data for video calls (e.g., participants, date and time, etc.) from video conferencing programs, desk telephone call data (e.g., caller, date and time of call, call duration, etc.) from desk telephone logs, mobile telephone call data (e.g., caller, date and time of call, call duration, location, etc.) from mobile telephone logs, and chat and messaging data (e.g., participants, time and date, topics, etc.) from chat and messaging logs.

Additional metadata, such as whether cameras were turned on during a virtual meeting, the length of the meeting, the number of emails in a chain, the number of email participants, the client's speed of response to an email or message, a sentiment in the response, etc. may also be collected.

In step 210, the computer program may use the data to generate a profile for each client or customer. For example, each client or customer may have a plurality of email addresses (e.g., work, personal, etc.), phone numbers (e.g., desk phone, corporate mobile phone, personal mobile phone, etc.), video conference addresses, chat and messaging handles, etc. For example, using metadata associated with each bit of data, the computer program may identify contact information that is likely to be associated with a single client. The computer program 115 may use common names, subjects, dates, electronic device data (e.g., device fingerprints), IP addresses, locations, etc. to identify common contact information for a client.

In one embodiment, the computer program may automatically update contact information for clients or customers as changes are identified. For example, each email may have its signature scraped, and if a change is identified (e.g., updated address, phone number, etc.), the client or customer contact information may be updated. The updated contact information may be pushed to interested users.

In step 215, the computer program may discount or exclude false positive client interactions. For example, embodiments may identify client interactions that are likely to be false positives, such as out-of-office replies, conversations with assistants, etc., and may remove them from the pool of interactions that are further considered.

In step 220, the computer program may score each customer or client interaction using, for example, a trained machine learning algorithm or artificial intelligence may be used to score each interaction. For example, example, an in-person meeting between a user and a client may be scored as a high value interaction. A virtual one-on-one meeting between the user and the client may be scored as a high value interaction. A direct user to client telephone call may be scored as a high value interaction. Group meetings, such as virtual group meetings, video or conference calls, etc., may have lower scores. In one embodiment, machine learning may be used to determine the score for each interaction.

In one embodiment, additional metadata, such as whether cameras were turned on during a virtual meeting, the length of the meeting, the number of emails in a chain, the number of email participants, the client's speed of response to an email or message, a sentiment in the response, etc., may also be used to determine the score.

In one embodiment, interactions may be grouped to assess a value for the interaction. For example, a long email interaction with a positive sentiment may have a value that may be similar to a one-on-one in-person meeting. This may also lead to discounting email that may include out of office replies, spam, etc.

In one embodiment, an interaction may be scored highly if it leads to a follow-up interaction. For example, a single email or message may be given a high value score if it leads to setting up or suggesting a follow-up meeting, such as an in-person meeting.

In step 225, the computer program may provide the client or customer interactions to a CRM program. This may include a user identifier (e.g., employee name), client/customer information, date and time, location, type of interaction, and a value score for the interactions.

In step 230, the CRM program may ingest the interactions and further process the interactions as is necessary and/or desired.

For example, the CRM program may use the value score for the interactions to discover unknown relationships (e.g., finding out that untapped individuals have strong, existing business relationships that can help optimize sales opportunities); to identify if a client relationship that is getting stale (e.g., due to a lack of observed, recent interactions) and to provide automatic recommendations for how to engage the business contacts with strong relationship candidates; to control advantages for when observed interactions indicate awareness of client/transaction activity outside of approved individual, thereby enabling engagement with the additional private side information situation with early stage procedures that help to ameliorate the concern; to increase a strength of a connection with the client based on the value score for the interactions; etc.

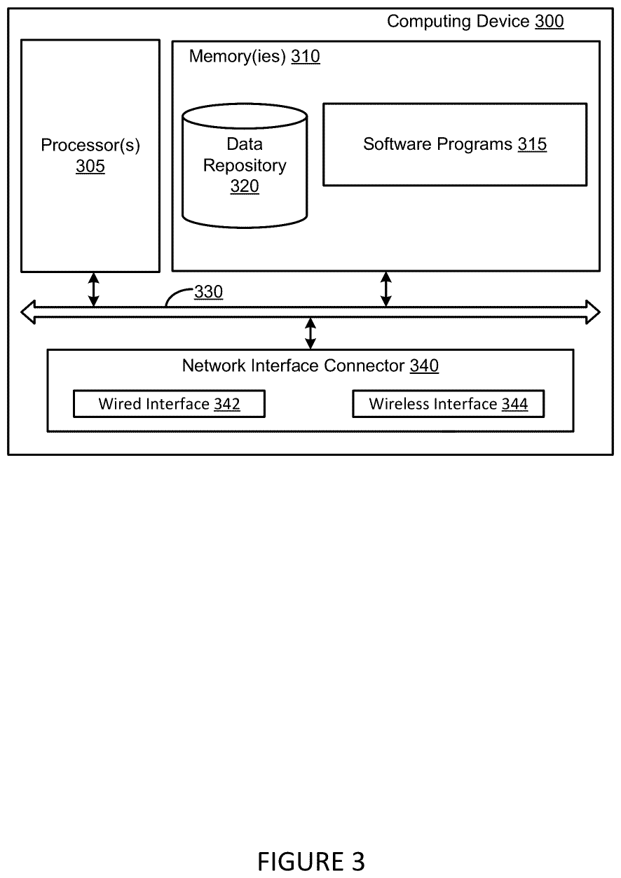

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be used to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed by a backend electronic device, client or customer interaction data for a plurality of client or customer interactions from a plurality of sources;
generating, by the computer program, an interaction value score each of the customer or client interactions using a trained machine learning algorithm; and
providing, by the computer program, the client or customer interactions and the interaction value score for each of the client or customer interactions to a customer relationship management computer program.

2. The method of claim 1, where the plurality of sources comprise calendaring programs, email programs, video conferencing programs, telephone logs, and/or chat and messaging data.

3. The method of claim 1, wherein the client or customer interaction data comprises meeting information.

4. The method of claim 3, wherein the meeting information comprises meeting dates, meeting participants, meeting subjects, and meeting locations.

5. The method of claim 4, wherein the meeting information further comprise a number of communications, a number of participants, and/or a sentiment.

6. The method of claim 1, further comprising:
generating, by the computer program and using the customer interaction data, a profile for each client or customer;
wherein the profile for each client or customer comprises a plurality of email addresses, a plurality of phone numbers, a video conference address, and/or a chat and messaging handle.

7. The method of claim 1, further comprising:
identifying, by the computer program, the client or customer in the client or customer interaction data using common names, subjects, dates, electronic device data, IP addresses, and/or locations in the client or customer interaction data.

8. The method of claim 1, further comprising:
identifying, by the computer program, false positive client or customer interactions; and
excluding or discounting, by the computer program, the client or customer interaction data associated with the identified false positive client or customer interactions.

9. The method of claim 8, wherein the false positive client or customer interactions comprise client or customer interaction data including an out-of-office reply and/or an interaction with an assistant.

10. The method of claim 1, wherein in-person client or customer interactions and/or direct client or customer interactions score as high value interactions, and virtual group client or customer interactions score are scored as lower value interactions.

11. A system, comprising:
a plurality of sources of client or customer interaction data;
a customer relationship manager computer system; and
a backend electronic device that is configured to receive, from the plurality of sources of client or customer interaction data, the client or customer interaction data for a plurality of client or customer interactions; to generate an interaction value score each of the customer or client interactions using a trained machine learning algorithm; and to provide the client or customer interactions and the interaction value score for each of the client or customer interactions to a customer resource management system.

12. The system of claim 11, where the plurality of sources of client or customer interaction data comprise calendaring programs, email programs, video conferencing programs, telephone logs, and/or chat and messaging data.

13. The system of claim 11, wherein the client or customer interaction data comprises meeting information.

14. The system of claim 13, wherein the meeting information comprises meeting dates, meeting participants, meeting subjects, and meeting locations.

15. The system of claim 14, wherein the meeting information further comprise a number of communications, a number of participants, and/or a sentiment.

16. The system of claim 11, wherein the backend electronic device is further configured to generate, using the customer interaction data, a profile for each client or customer, wherein the profile for each client or customer comprises a plurality of email addresses, a plurality of phone numbers, a video conference address, and/or a chat and messaging handle.

17. The system of claim 11, wherein the backend electronic device is further configured to identify the client or customer in the client or customer interaction data using common names, subjects, dates, electronic device data, IP addresses, and/or locations in the client or customer interaction data.

18. The system of claim 11, wherein the backend electronic device is further configured to identify false positive client or customer interactions; and to exclude or discount the client or customer interaction data associated with the identified false positive client or customer interactions.

19. The system of claim 18, wherein the false positive client or customer interactions comprise client or customer interaction data including an out-of-office reply and/or an interaction with an assistant.

20. The system of claim 11, wherein in-person client or customer interactions and/or direct client or customer interactions score as high value interactions, and virtual group client or customer interactions score are scored as lower value interactions.
